(19) United States
(12) Patent Application Publication
(10) Pub. No.: US 2022/0383420 A1
(43) Pub. Date: Dec. 1, 2022

(54) SYSTEM FOR DETERMINING VEHICLE DAMAGE AND DRIVABILITY AND FOR CONNECTING TO REMOTE SERVICES

(71) Applicant: GM GLOBAL TECHNOLOGY OPERATIONS LLC, Detroit, MI (US)

(72) Inventors: Matthew Edward GILBERT-EYRES, Rochester, MI (US); Russell A. PATENAUDE, Macomb Township, MI (US); Eric T. HOSEY, Royal Oak, MI (US); Matt NEELY, Rochester, MI (US)

(21) Appl. No.: 17/332,274

(22) Filed: May 27, 2021

(51) Int. Cl. G06Q 40/08; G06Q 30/02; G07C 5/08

(52) U.S. Cl. CPC G06Q 40/08; G06Q 30/0283; G07C 5/085

(57) ABSTRACT

A server for a telematics system includes a processor and memory. An application stored in the memory includes instructions that are executable by the processor and that are configured to receive vehicle data from a vehicle located remote from the server via a telematics system of the vehicle. The vehicle data includes a location of the vehicle, measured vehicle data, and vehicle diagnostic data sampled after the vehicle was involved in a crash event. The application generates a vehicle damage report based on the vehicle data sampled after the vehicle was involved in a crash event and generates a driveability score for the vehicle based on the vehicle damage report.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for assessing damage to a vehicle involved in a crash.

Telematics systems such as OnStar provide advanced automatic crash notification (AACN). AACN sends telemetry data that is measured by sensors of the vehicle in the event of a crash. The telemetry data can be used to accurately predict the injury severity of vehicle occupants. If the telemetry data indicates that a severe injury is likely, the telematics system automatically calls for medical and police assistance without input from the occupants.

### SUMMARY

A server for a telematics system includes a processor and memory. An application stored in the memory includes instructions that are executable by the processor and that are configured to receive vehicle data from a vehicle located remote from the server via a telematics system of the vehicle. The vehicle data includes a location of the vehicle, measured vehicle data, and vehicle diagnostic data sampled after the vehicle was involved in a crash event. The application generates a vehicle damage report based on the vehicle data sampled after the vehicle was involved in a crash event and generates a driveability score for the vehicle based on the vehicle damage report.

In other features, the application selectively sends a message to a towing service requesting a tow truck to be sent to the location of the vehicle based on the driveability score without interacting with occupants of the vehicle.

In other features, the application is further configured to compare the driveability score to a predetermined drivability threshold; declare the vehicle driveable if the driveability score is greater than a predetermined driveability threshold; and declare the vehicle not driveable if the driveability score is less than the predetermined drivability threshold.

In other features, the application selectively sends a message to an advisor to contact occupants of the vehicle in response to the driveability score without requiring occupants of the vehicle to initiate contact.

In other features, the application generates a damage estimate based on the vehicle data and the vehicle diagnostic data.

In other features, the application is further configured to receive the vehicle data and the vehicle diagnostic data at different sampling times after the vehicle was involved in the crash event.

In other features, the application is further configured to generate delta data based on the vehicle data taken at the different sampling times; and at least one of estimate damage to the vehicle based on the delta data and calculate the driveability score based on the delta data.

In other features, the application retrieves a vehicle history corresponding to at least one of a service history and accident history the vehicle; retrieves vehicle trim data; retrieves vehicle mileage from the vehicle data; and retrieves vehicle value data corresponding to a current value of the vehicle at the vehicle mileage. Based on the vehicle damage report, the vehicle history and the current value of the vehicle, the application selectively generates a recommendation whether or not to total the vehicle. The application is further configured to send the vehicle damage report to an insurance company via a distributed communication system.

A method for operating a telematics system includes receiving vehicle data from a vehicle via a telematics system of the vehicle. The vehicle data includes a location of the vehicle, measured vehicle data, and vehicle diagnostic data sampled after the vehicle was involved in a crash event. The method further includes generating a vehicle damage report based on the vehicle data sampled after the vehicle was involved in a crash event and generating a driveability score for the vehicle based on the vehicle damage report.

In other features, the method includes selectively sending a message to a towing service requesting a tow truck to be sent to the location of the vehicle based on the driveability score without interacting with occupants of the vehicle.

In other features, the method includes comparing the driveability score to a predetermined drivability threshold; declaring the vehicle driveable if the driveability score is greater than a predetermined driveability threshold; and declaring the vehicle not driveable if the driveability score is less than the predetermined drivability threshold.

In other features, the method includes sending a message to an advisor to contact occupants of the vehicle in response to the driveability score without requiring occupants of the vehicle to initiate contact. The method includes generating a damage estimate based on the vehicle data and the vehicle diagnostic data. The method includes receiving the vehicle data and the vehicle diagnostic data taken at different sampling times after the vehicle was involved in the crash event.

In other features, the method includes generating delta data based on the vehicle data taken at the different sampling times; and at least one of estimating damage to the vehicle based on the delta data and calculating the driveability score based on the delta data.

In other features, the method includes retrieving a vehicle history corresponding to at least one of a service history and accident history the vehicle; retrieving trim data corresponding to the vehicle; retrieving vehicle mileage from the vehicle data; and retrieving vehicle value data corresponding to a current value of the vehicle at the vehicle mileage.

In other features, the method includes selectively generating a recommendation whether or not to total the vehicle based on the vehicle damage report, the vehicle history and the current value of the vehicle. The method includes transmitting the vehicle damage report to an insurance company via a distributed communication system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a system for determining vehicle damage and evaluating drivability according to the present disclosure;

FIGS. 2 and 3 are flowcharts of an example of a method for evaluating vehicle drivability after a crash event according to the present disclosure;

FIG. 4 is a flowchart of an example of a method for transmitting data from the vehicle to a remote server in response to a crash event;

FIG. 5 is a flowchart of an example of a method for generating a damage report for the vehicle in response to a crash event;

FIG. 6 is a flowchart of an example of a method for automatically contacting a towing service in response to a crash event; and

FIG. 7 is a flowchart of an example of a method for estimating damage to the vehicle based on a damage report.

In the drawings, reference numbers may be reused to identify similar and/or identical elements.

### DETAILED DESCRIPTION

While telematics systems such as OnStar provide advanced automatic crash notification (AACN), the telematics system automatically calls for medical and police assistance only if the telemetry data indicates that a severe injury is likely to have occurred. While this approach works for injured vehicle occupants, a large number of accidents are excluded by this approach. Some of the excluded accidents fall below the threshold for automatically initiating the call for medical and police assistance while still having significant vehicle damage. The vehicle may be in a non-operative condition and the occupant would need to initiate the call for towing services. In some situations, the driver of the vehicle may be distressed due to the accident and may not be thinking clearly.

In addition, after an accident, the process for repairing the vehicle can take a significant amount of time. The owner of the vehicle typically needs to contact the insurance company, file a claim, wait for an adjuster to view the vehicle and prepare a report, and then wait to be contacted before initiating repairs. The associated delays can be a cause for customer dissatisfaction.

Systems and methods described herein provide significant assistance to the owner of the vehicle in the event of an accident. The systems and methods transmit vehicle data collected during one or more sampling times after a crash to evaluate the drivability of the vehicle (e.g. generate a driveability score) and/or to estimate the damage to the vehicle. In some examples, the drivability score is generated and compared to a predetermined drivability threshold. If the drivability score is less than the predetermined drivability threshold, the vehicle is declared not driveable and an advisor can contact the vehicle and/or a towing service and/or send a tow truck without interacting with the occupants of the vehicle or the advisor.

In some examples, the systems and methods create a vehicle damage report and transmit the vehicle damage report to an advisor to assist the advisor. In some examples, the advisor initiates a call to the vehicle in response to the vehicle damage report. The vehicle damage report may also be used to create an insurance claim and/or to transmit a message or alert to the insurance company. In some examples, the vehicle data is used to estimate the damage to the vehicle, to estimate the cost to repair and/or to determine whether or not the vehicle is likely to be totaled based thereon. As can be appreciated, the systems and methods described herein reduce the time required to obtain assistance at the scene of the accident, to obtain an estimate of the damage, to determine whether or not the vehicle will likely be totaled and/or to process a claim with an insurance company.

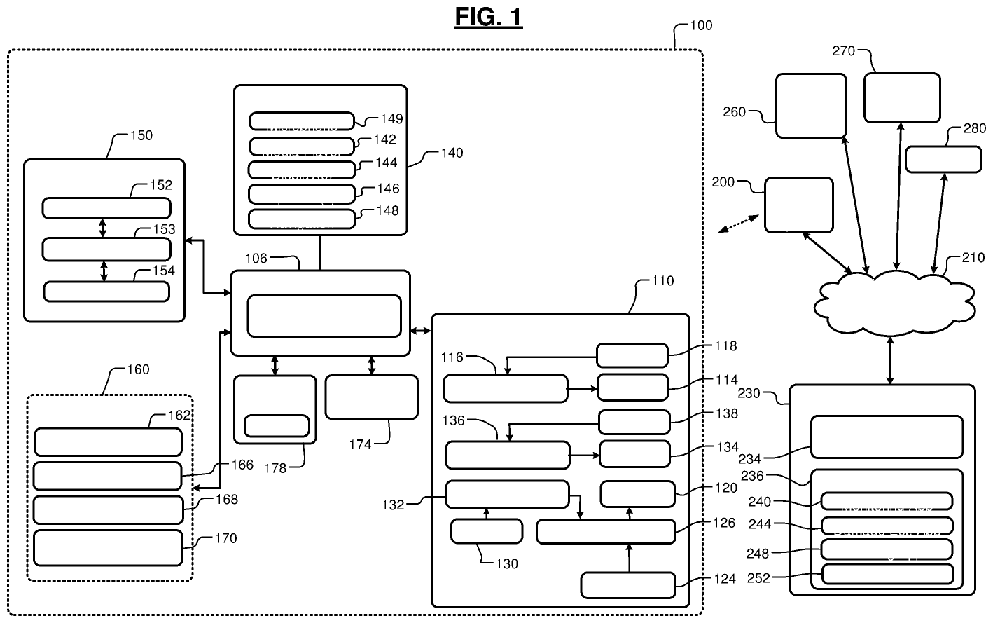

Referring now to FIG. 1, a vehicle 100 includes a system for determining vehicle damage and drivability according to the present disclosure. The vehicle 100 includes a controller 106 storing vehicle data, diagnostic codes and/or other information that is generated during normal operation. After a crash event has occurred, additional vehicle data is collected and automatically transmitted to a remote server.

The vehicle 100 includes a propulsion system 110 including an internal combustion engine (ICE) 114 and/or one or more electric motors 120. In other words, the vehicle 100 can be a conventional vehicle powered by an ICE, a hybrid vehicle powered by an ICE and one or more electric motors, or a battery electric vehicle powered by an electric motor. An engine controller 116 controls actuators of the ICE 114 based on feedback from sensors 118 such as temperature sensors, pressure sensors, speed sensors, etc.

The electric motor 120 receives power from one or more battery packs 124 via switches and/or DC/AC converters 126. A motor controller 132 controls the electric motor 120 based on feedback from one or more sensors 130. Examples of the sensors 130 include voltage sensors, current sensors, speed sensors, etc. A transmission 134 or other mechanical coupling connects an output of the ICE 114 and/or the electric motor(s) 120 to wheels of the vehicle 100. In some examples, a transmission controller 136 controls operation of the transmissions 134 based on feedback from one or more sensors 138.

The vehicle 100 includes an infotainment module 140 including a media player 142, one or more displays 144, one or more speakers 146, a navigation module 148, and/or one or more microphones 149. A telematics module 150 includes a wireless transceiver 152 to communicate with a wireless network, a controller 153 and a global positioning system (GPS) module 154 to provide GPS signals to the navigation module 148.

The vehicle 100 further includes one or more sensors 160 such as one or more cameras 162 (inwardly or outwardly facing cameras), tire pressure sensors 168, fuel level sensors 170, glass break sensors 166, etc. In some examples, the glass break sensors 166 monitor the microphones 149 to detect sounds corresponding to glass breaking. The vehicle 100 includes an air bag system 178 and a seat belt pretensioner 174.

The telematics module 150 transmits and receives vehicle data, audio data and/or other information via a wireless communication system 200 such as a cellular system, a satellite system or other type of wireless communication system. The wireless communication system 200 is connected to a distributed communication system 210 such as the Internet. Data from the vehicle 100 is transmitted by the wireless communication system 200 and the distributed communication system 210 to a remote server 230 that includes a processor 234 and memory 236.

The memory 236 includes a damage monitoring application 240 that receives vehicle data after a vehicle is involved in a crash event, evaluates vehicle damage and generates vehicle damage reports. A damage estimating application 244 estimates the repair cost of the vehicle damage based on the vehicle damage report and/or determines whether the vehicle should be totaled based on the vehicle damage estimate and other vehicle information. A towing application 248 determines whether or not a towing vehicle is required based on the vehicle damage report, automatically sends a message to a vehicle towing service with vehicle identifying information and location and/or alerts an advisor (associated with the vendor of the telematics system, the vehicle manufacturer or another service provider) to initiate contact with the vehicle and make the determination based thereon. A database 252 stores vehicle data for each vehicle, a repair data store or knowledge base, etc.

In some examples, the remote server 230 sends the vehicle data, the vehicle damage report, the vehicle damage evaluation and/or other information to a server 270 associated with an advisor, a server 260 associated with a towing service and/or a computer 280 associated with the vehicle owner. In some examples, the remote server 230 sends vehicle description, vehicle location and/or vehicle condition to a towing service to initiate towing.

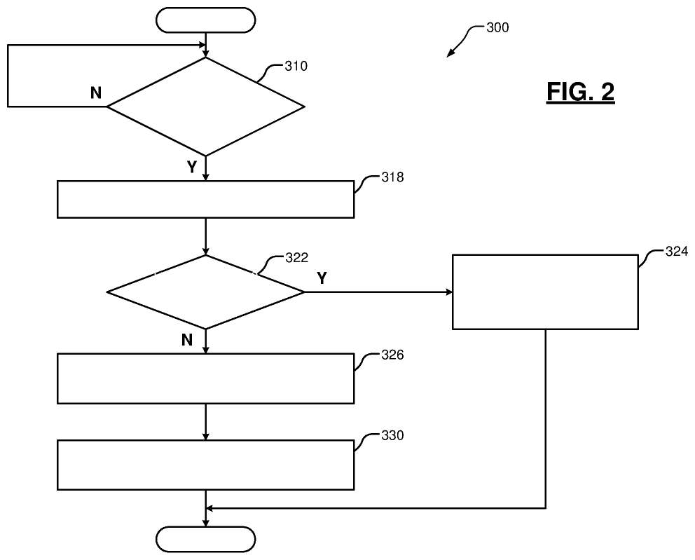

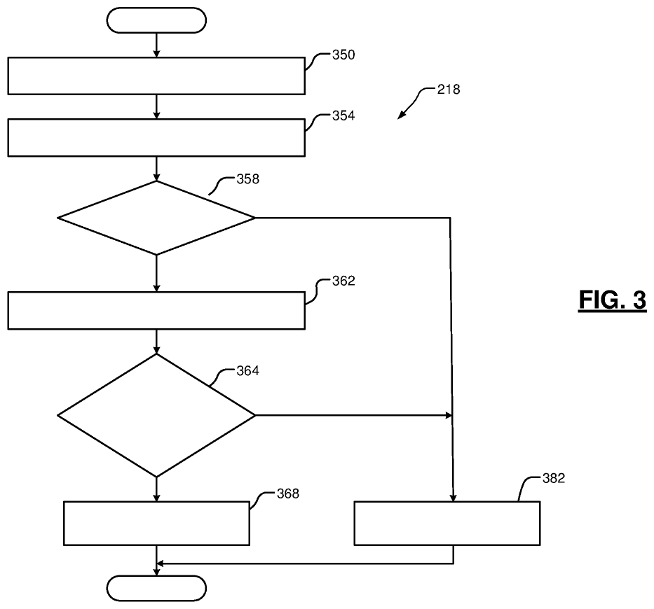

Referring now to FIGS. 2 and 3, a method 300 for diagnosing vehicle drivability after a crash event is shown. At 310, the method determines whether a low level impact or an advanced automatic crash notification (AACN) is detected. If 310 is true, the method performs a vehicle driveability analysis at 318 as described further in FIG. 3.

If the vehicle is drivable as determined at 322, the method generates a prompt using the infotainment system allowing the user an option to place a telematics call. If 322 is false, the method automatically initiates a call to an advisor using the telematics system. At 330, data from the driveability evaluation is sent to a remote server.

In FIG. 3, a driveability evaluation is shown. At 350, vehicle health data is collected. At 354, a vehicle diagnostic check is performed to identify diagnostic codes. At 358, the method determines whether any of the active diagnostic codes are within a predetermined set of diagnostic codes that are deemed critical. Non-limiting examples of critical diagnostic codes include airbag deployment, seat belt pretensioner deployment, and certain engine or transmission codes (such as those corresponding to diagnostic codes causing flashing check engine lights).

If 358 is true, the vehicle is declared not driveable at 362. If 358 is false, the vehicle runs a vehicle data check at 362. At 364, the method determines whether critical data elements are within or outside predetermined limits or ranges. If 364 is true, the method continues with 382. If 364 is false, the vehicle is declared driveable at 368.

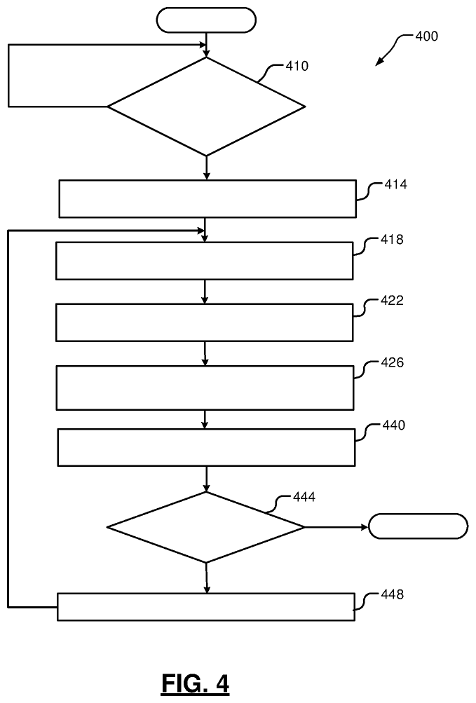

As can be appreciated, collection of vehicle data, vehicle health data and/or diagnostic checks can be run at predetermined intervals to further aid the vehicle driveability determination and/or to estimate damage. In other words, the vehicle data is initially determined soon after the crash event. However, some damage will be more evident by analyzing changes in data values or rates of change over time. In FIG. 4, a method 400 for running multiple vehicle data collection, health check and/or diagnostic checks at predetermined intervals in response to a crash event are shown.

At 410, the method determines if a low level impact or AACN is detected. If 410 is true, the method proceeds to 414, starts a timer and sets N=1, where N is an integer. At 418, the method collects vehicle data. At 418, the method runs vehicle diagnostic checks and/or health checks. At 426, the vehicle transmits vehicle data, diagnostic codes and/or health data to the remote server. At 440, the method waits a predetermined period. While predetermined intervals are shown, the intervals can be variable, event based, conditional, etc. At 444, the method determines whether N=M, where M is an integer greater than one. If 444 is true, the method ends. If 444 is false, the method increments N at 446 and returns to 418.

In some examples, the damage that the vehicle has suffered is evaluated using diagnostic codes, the vehicle data and the vehicle health data. Either the vehicle pushes the data automatically and/or the remote server sends a request to pull the data from the vehicle multiple times at predetermined intervals, variable intervals or in response to events. As will be described further below, the remote server compares the data to predetermined values, thresholds, ranges, etc. to determine whether there are any data values or changes in data values indicative of vehicle damage.

For example, vehicle data such as tire pressure may be monitored over time to determine whether the tire pressure is dropping. Likewise, the oil level may be monitored over time to detect loss of oil due to the crash. Engine temperature is monitored over time to determine whether there is a coolant leak.

Examples of data values that are monitored include oil pressure via oil pressure sensors, fuel level via a fuel level sensor, battery voltage level(s), etc. Other data to be monitored and that are indicative of vehicle damage includes air bag deployment, pretensioner deployment, high voltage cutoff, and/or glass break sensors. Other indicators of damage include the change in velocity (delta V) during the crash impact. Video and/or picture data from the internal and/or external cameras can also be used to detect damage.

For example, the vehicle data that is collected is compared to predetermined values. If the engine temperature of the vehicle is currently at 200° C. and the predetermined (or expected) temperature is 100° C., the engine is running abnormally and most likely coolant is leaking or radiator damage has occurred.

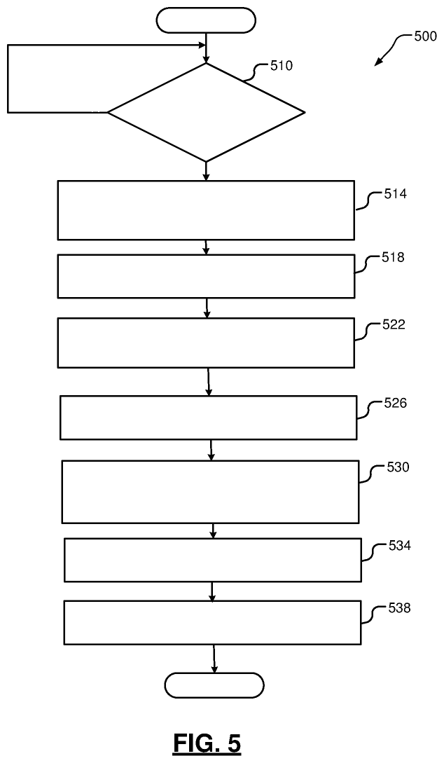

Referring now to FIG. 5, a method 500 for generating a damage report for the vehicle in response to a crash event. At 510, the method determines whether vehicle data, diagnostic codes and/or health data have been received from a vehicle. If 510 is true, the method continues at 514 and stores vehicle data, health data and diagnostic codes with the sample time. At 518, the method estimates vehicle damage by comparing data values to predetermined values. At 522, the method estimates vehicle damage based on diagnostic codes. At 526, the method estimates vehicle damage based on video from cameras. At 530, the method generates delta values and/or rates of change based on vehicle data samples taken at different times. At 534, the method estimates vehicle damage based on the delta values and/or rates of change. At 538, the method generates a damage report for the vehicle based on steps 514-534.

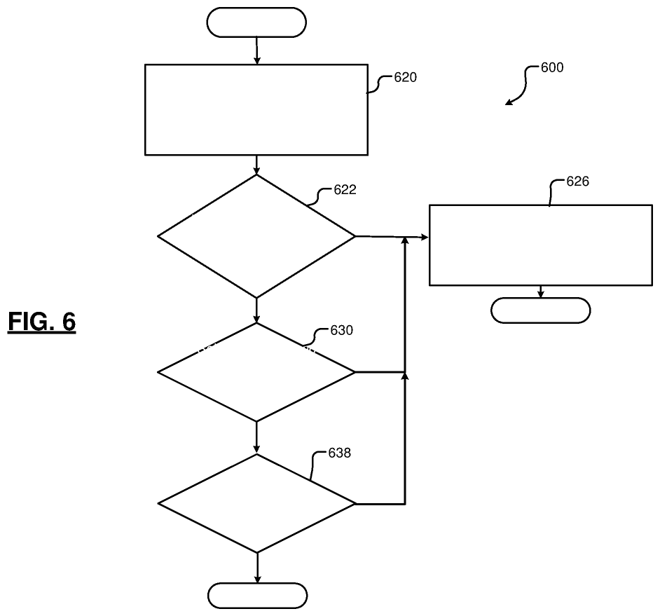

Referring now to FIG. 6, a method 600 automatically and selectively contacts an advisor and/or a towing service in response to a crash event based on the vehicle damage report and/or the driveability score. At 620, the method identifies selected vehicle data values, health data values and/or diagnostic codes that indicate the probably need for towing. At 622, the method determines whether the selected data values and/or health data values indicate towing is required. If 622 is false, the method continues at 630 and determines whether selected diagnostic codes that typically correspond to damage requiring towing are asserted. If 630 is false, the method continues at 638 and determines whether delta values indicate that towing is required. If 622, 630 or 638 are true, the method continues at 626 and sends a message to a towing service to send a truck to the vehicle location without occupant input.

Alternately, a message including the vehicle damage report and/or drivability determination or score is sent to an advisor who either makes the decision to send a towing vehicle and/or contacts the occupants of the vehicle to confirm the decision. Alternately, an automated call to the vehicle can be generated and can provide an option for towing services to be sent. While the driveability decision described above treats the various types of data individually, a driveability score can be generated based on all of the data types. The driveability score is compared to a driveability threshold to determine whether or not the advisor and/or towing service should be contacted and/or the automated call initiated.

For example, there is a high likelihood that a towing vehicle will be required if the diagnostic code corresponds to airbag or pretensioner deployment. Other vehicle data or delta data indicative of a need for towing includes a tire pressure (delta tire pressure in a given tire or between different tires, or absolute tire pressure in one or more tires less than a predetermined value), high voltage shutdown, V_{BATT} missing, low engine oil, certain types of engine or transmission diagnostic codes (such as those corresponding to flashing check engine or service indicators).

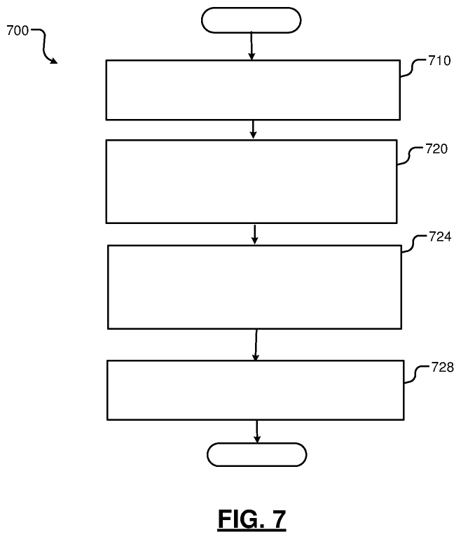

Referring now to FIG. 7, a method 700 estimates damage to the vehicle based on a vehicle damage report. At 710, the method uses the vehicle damage report to identify damage to specific vehicle components. At 720, the method determines one or more of vehicle age, trim, mileage, service history, prior collision history, blue book value, and/or location history. At 724, the method generates vehicle damage assessment, cost to repair and/or decision to total the vehicle based the sum of damaged components, vehicle info and vehicle history. At 728, the method transmits the vehicle damage assessment including a vehicle damage estimate and/or the decision to total the vehicle to insurance company, manufacturer, and/or owner.

The vehicle damage assessment is generated by accessing lookup tables or a knowledge base stored in the database based on the vehicle damage report, the vehicle data, the health data, and the diagnostic codes. The vehicle damage assessment also bases the vehicle damage estimate on vehicle information such as vehicle age, trim level, mileage, service history, prior collision history, blue book value, location history and the like.

For example only, a vehicle is involved in a crash event. After the crash event, the vehicle transmits vehicle data, health data and/or diagnostic data to the remote server one or more times. Based on the transmitted data, the remote server determines that the airbag deployed, the seatbelt pretensioner deployed, a window was damaged, two tires are flat and three diagnostic codes are set. A tow truck can be sent without interaction with the occupant based on one or more of reported data items such as the flat tires, seatbelt or airbag deployment, broken window and/or the diagnostic codes.

The vehicle damage estimate can be based on the cost to replace the airbag for the vehicle, the seatbelt pretensioner, the window and the tires and further based on likely repairs addressing the diagnostic codes that were set. Further, the decision to total the vehicle can be based on a comparison between the vehicle damage estimate and the blue book value. The vehicle damage report and vehicle damage estimate can be transmitted to the owner, the manufacturer and/or an insurance company.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A server for a telematics system, comprising:
a processor;
memory; and
an application stored in the memory including instructions that are executable by the processor and that are configured to:
receive vehicle data from a vehicle located remote from the server via a telematics system of the vehicle,
wherein the vehicle data includes a location of the vehicle, measured vehicle data, and vehicle diagnostic data sampled after the vehicle was involved in a crash event;
generate a vehicle damage report based on the vehicle data sampled after the vehicle was involved in a crash event; and
generate a driveability score for the vehicle based on the vehicle damage report.

2. The server of claim 1, wherein the application selectively sends a message to a towing service requesting a tow truck to be sent to the location of the vehicle based on the driveability score without interacting with occupants of the vehicle.

3. The server of claim 1, wherein the application is further configured to:
compare the driveability score to a predetermined drivability threshold;
declare the vehicle driveable if the driveability score is greater than a predetermined driveability threshold; and
declare the vehicle not driveable if the driveability score is less than the predetermined drivability threshold.

4. The server of claim 1, wherein the application is further configured to selectively send a message to an advisor to contact occupants of the vehicle in response to the driveability score without requiring occupants of the vehicle to initiate contact.

5. The server of claim 1, wherein the application is further configured to generate a damage estimate based on the vehicle data and the vehicle diagnostic data.

6. The server of claim 1, wherein the application is further configured to receive the vehicle data and the vehicle diagnostic data at different sampling times after the vehicle was involved in the crash event.

7. The server of claim 6, wherein the application is further configured to:
generate delta data based on the vehicle data taken at the different sampling times; and
at least one of:
estimate damage to the vehicle based on the delta data; and
calculate the driveability score based on the delta data.

8. The server of claim 1, wherein the application is further configured to:
retrieve a vehicle history corresponding to at least one of a service history and accident history the vehicle;
retrieve vehicle trim data;
retrieve vehicle mileage from the vehicle data; and
retrieve vehicle value data corresponding to a current value of the vehicle at the vehicle mileage.

9. The server of claim 8, wherein, based on the vehicle damage report, the vehicle history and the current value of the vehicle, the application is further configured to selectively generate a recommendation whether or not to total the vehicle.

10. The server of claim 1, wherein the application is further configured to send the vehicle damage report to an insurance company via a distributed communication system.

11. A method for operating a telematics system, comprising:
receiving vehicle data from a vehicle via a telematics system of the vehicle,
wherein the vehicle data includes a location of the vehicle, measured vehicle data, and vehicle diagnostic data sampled after the vehicle was involved in a crash event;
generating a vehicle damage report based on the vehicle data sampled after the vehicle was involved in a crash event; and
generating a driveability score for the vehicle based on the vehicle damage report.

12. The method of claim 11, further comprising selectively sending a message to a towing service requesting a tow truck to be sent to the location of the vehicle based on the driveability score without interacting with occupants of the vehicle.

13. The method of claim 11, further comprising:
comparing the driveability score to a predetermined drivability threshold;
declaring the vehicle driveable if the driveability score is greater than a predetermined driveability threshold; and
declaring the vehicle not driveable if the driveability score is less than the predetermined drivability threshold.

14. The method of claim 11, further comprising sending a message to an advisor to contact occupants of the vehicle in response to the driveability score without requiring occupants of the vehicle to initiate contact.

15. The method of claim 11, further comprising generating a damage estimate based on the vehicle data and the vehicle diagnostic data.

16. The method of claim 11, further comprising receiving the vehicle data and the vehicle diagnostic data taken at different sampling times after the vehicle was involved in the crash event.

17. The method of claim 16, further comprising
generating delta data based on the vehicle data taken at the different sampling times; and
at least one of:
estimating damage to the vehicle based on the delta data; and
calculating the driveability score based on the delta data.

18. The method of claim 11, further comprising:
retrieving a vehicle history corresponding to at least one of a service history and accident history the vehicle;
retrieving trim data corresponding to the vehicle;
retrieving vehicle mileage from the vehicle data; and
retrieving vehicle value data corresponding to a current value of the vehicle at the vehicle mileage.

19. The method of claim 18, further comprising selectively generating a recommendation whether or not to total the vehicle based on the vehicle damage report, the vehicle history and the current value of the vehicle.

20. The method of claim 11, further comprising transmitting the vehicle damage report to an insurance company via a distributed communication system.
